(19) United States
(12) Patent Application Publication
(10) Pub. No.: US 2003/0017332 A1
(43) Pub. Date: Jan. 23, 2003

(54) Acrylic sheet and acrylic pressure-sensitive adhesive sheet

(76) Inventors: Youichi Takizawa, Saitama (JP); Tetsuya Yoshida, Saitama (JP)

Correspondence Address: Kent E Baldauf, 700 Koppers Building, 436 Seventh Avenue, Pittsburgh, PA, 15219-1818, US

(21) Appl. No.: 10/181,117

(22) PCT Filed: Jan. 12, 2001
(86) PCT No.: PCT/JP01/00132

(30) Foreign Application Priority Data
Jan. 13, 2000 (JP) 2000-4791
Apr. 21, 2000 (JP) 2000-120301

(51) Int. Cl. B32B 1/02; B65D 1/00

(52) U.S. Cl. 428/343; 428/35.7

(57) ABSTRACT

The acrylic sheet of the invention is an acrylic sheet mainly having excellent suitability for adhesion to a three-dimensional curved surface, and is formed from an acrylic resin comprising a crosslinked acrylic polymer having a structure obtained by crosslinking 100 parts by weight of an acrylic polymer, which is a (co)polymer of a monomer containing an alkyl (meth)acrylate as a main component and has Tg of −10 to 30° C. and a weight-average molecular weight of 100000 to 500000, with 0.1 to 10 parts by weight of an epoxy crosslinking agent having two or more epoxy groups in its molecule and/or 1 to 30 parts by weight of an isocyanate crosslinking agent having two or more isocyanate groups in its molecule. This acrylic sheet is excellent in the three-dimensional curved surface-follow properties and in the printability.

### TECHNICAL FIELD

The present invention relates to acrylic sheets and acrylic adhesive sheets to be stuck as exterior trim materials onto three-dimensional curved surfaces of general industrial products such as automobile parts, motor-bicycle parts and household appliances.

### BACKGROUND ART

For general industrial products such as automobile parts, motor-bicycle parts and household appliances, designing has been regarded as important, and three-dimensional curved surfaces have been used very often. Of the parts having three-dimensional curved surfaces, those made of resins are usually colored by incorporating pigments and dyes into resin materials and then molding the resin materials into desired shapes, while those made of metals are usually ornamentalized by coating the molded products with paints after molding resin materials into desired shapes. Thus, the desired designs are attained. Since the colored molded products for these parts are usually manufactured continuously, the types of the colors used for the parts are restricted to a certain extent, and in fact, such methods can be not used for so many colored molded products.

Recently, diversification of designing and designs has been required, and to meet such requirement, colored resin sheets are stuck to these parts entirely or partially to display desired patterns or letters. The resin sheets need to have properties of colorability, printability and the like, and in order to stick the resin sheets onto curved surfaces, they need to have moderate flexibility, elongation and strength. Therefore, vinyl chloride resin sheets have been now employed.

However, it has been reported that the vinyl chloride resin generates a dioxine gas when incinerated together with other resins, and under such circumstances, use of the vinyl chloride resin should be restrained.

In order to ensure good adhesion properties of the vinyl chloride resin sheet to the three-dimensional curved surface, it is necessary to add a large amount of a plasticizer giving flexibility and elastomeric properties to the vinyl chloride resin for these properties to the resin sheet.

As the plasticizer used for such purpose, a phthalic acid compound has been widely used. In recent years, however, there is a fear of an influence of the phthalic acid compound on the ecosystem.

Under the circumstances relating to the vinyl chloride resin sheets having been heretofore widely used as the sheets to be stuck to the three-dimensional curved surfaces, there has been earnestly desired development of three-dimensional curved surface adhesive sheets free from the above problems as substitutes for the vinyl chloride resin sheets.

For example, it has been studied to use conventional polyolefin sheets and acrylic resin sheets mainly containing methyl methacrylate as substitutes for the vinyl chloride resin sheets. The polyolefin sheets and the acrylic resin sheets, however, cannot reach the vinyl chloride resin sheets in the properties of printability, flexibility, elongation and strength, and any resin sheet having properties equal to those of the vinyl chloride resin sheets and satisfying properties of the three-dimensional curved surface adhesive sheets has not been obtained yet.

### DISCLOSURE OF THE INVENTION

It is an object of the present invention to provide a resin sheet having properties of printability, flexibility, elongation and strength equal to or higher than those of a vinyl chloride resin sheet having been widely used as a sheet to be stuck to a three-dimensional curved surface, and to provide an acrylic adhesive sheet using the resin sheet. It is another object of the invention to provide a resin sheet which can be used as a three-dimensional curved surface adhesive sheet of excellent printability, flexibility, elongation and strength similarly to a vinyl chloride resin sheet even if a plasticizer is not added, and to provide an acrylic adhesive sheet using the resin sheet.

The present inventors have studied various acrylic resin sheets having excellent weathering resistance and safety as substitutes for the vinyl chloride resin sheets, and as a result, they have found that an acrylic sheet comprising a crosslinked acrylic polymer having a structure obtained by crosslinking a specific acrylic polymer with a specific crosslinking agent exhibits printability, flexibility, elongation and strength equal to or higher than those of the vinyl chloride resin sheets and that this crosslinked acrylic sheet has excellent curved surface-follow properties. Based on the finding, the present invention has been accomplished.

The acrylic sheet according to the present invention is a sheet comprising a crosslinked acrylic polymer having a structure obtained by crosslinking 100 parts by weight of an acrylic polymer, which is a (co)polymer of a monomer containing an alkyl (meth)acrylate as a main component and has a glass transition temperature (Tg) of −10 to 30° C. and a weight-average molecular weight, as measured by gel permeation chromatography (GPC), of 100000 to 500000, with 0.1 to 10 parts by weight of an epoxy crosslinking agent having two or more epoxy groups in its molecule and/or 1 to 30 parts by weight of an isocyanate crosslinking agent having two or more isocyanate groups in its molecule.

The acrylic sheet of the invention has a thickness of 0.005 to 0.2 mm.

The acrylic adhesive sheet according to the present invention is a sheet comprising an acrylic sheet and an adhesive layer formed on at least one surface of the acrylic sheet, wherein the acrylic sheet comprises a crosslinked acrylic polymer having a structure obtained by crosslinking 100 parts by weight of an acrylic polymer, which is a (co)polymer of a monomer containing an alkyl (meth)acrylate as a main component and has a glass transition temperature (Tg) of −10 to 30° C. and a weight-average molecular weight, as measured by gel permeation chromatography (GPC), of 100000 to 500000, with 0.1 to 10 parts by weight of an epoxy crosslinking agent having two or more epoxy groups in its molecule and/or 1 to 30 parts by weight of an isocyanate crosslinking agent having two or more isocyanate groups in its molecule.

The acrylic sheet or the acrylic adhesive sheet can be favorably used as, for example, a decorative sheet for a gasoline tank of a motor-bicycle.

### BEST MODE FOR CARRYING OUT THE INVENTION

The acrylic sheet and the acrylic adhesive sheet according to the invention and uses thereof are described in detail hereinafter.

The acrylic sheet of the invention comprises an acrylic resin containing a crosslinked acrylic polymer having a crosslinked structure formed by crosslinking 100 parts by weight of an acrylic polymer, which is prepared by (co)polymerizing a monomer containing an alkyl (meth)acrylate as a main component and has a glass transition temperature (Tg) of −10 to 30° C. and a weight-average molecular weight, as measured by gel permeation chromatography (GPC), of 100000 to 500000, with:

(A) 0.5 to 5 parts by weight of an epoxy crosslinking agent having two or more epoxy groups, and/or

(B) 1 to 30 parts by weight of an isocyanate crosslinking agent having two or more isocyanate groups.

The glass transition temperature (Tg) of the acrylic polymer used for preparing the acrylic sheet of the invention needs to be in the range of −10 to 30° C. and is preferably in the range of −5 to 20° C. If the glass transition temperature (Tg) of the acrylic polymer is lower than −10° C., the resulting acrylic sheet is liable to adhere to another acrylic sheet when they are placed one upon the other. For example, a rolled adhesive sheet is liable to suffer blocking. If the glass transition temperature is higher than 30° C., the resulting adhesive sheet has low flexibility and exhibits poor suitability for adhesion to a three-dimensional curved surface. In the present invention, the glass transition temperature (Tg) means a glass transition temperature of a polymer determined by the Fox's formula.

The acrylic polymer used for preparing the acrylic sheet of the invention can be obtained by polymerizing an acrylic monomer containing an alkyl (meth)acrylate as a main component through bulk polymerization, solution polymerization, emulsion polymerization, suspension polymerization or the like.

That is to say, the acrylic polymer used herein is obtained by (co)polymerizing a monomer containing an alkyl (meth)acrylate as a main component and a monomer containing in its molecule a functional group that is reactive to an epoxy group and/or an isocyanate group. Examples of the alkyl (meth)acrylates employable for preparing the acrylic polymer in the invention include alkyl (meth)acrylates wherein the number of carbon atoms to constitute an alkyl chain is in the range of about 1 to 12, such as methyl (meth)acrylate, ethyl (meth)acrylate, propyl (meth)acrylate, butyl (meth)acrylate, pentyl (meth)acrylate, hexyl (meth)acrylate, 2-ethylhexyl (meth)acrylate, octyl (meth)acrylate, nonyl (meth)acrylate, decyl (meth)acrylate and dodecyl (meth)acrylate. Examples of the monomers having a functional group reactive to an epoxy group and/or an isocyanate group include carboxyl group-containing monomers, such as (meth)acrylic acid, itaconic acid, crotonic acid, maleic acid and fumaric acid; hydroxyl group-containing monomers, such as 2-hydroxyethyl (meth)acrylate; and amido group-containing monomers, such as acrylamide, methacrylamide, N-methylolmethacrylamide and N-methoxyethylmethacrylamide.

When the acrylic sheet of the invention is formed from a crosslinked acrylic polymer having a crosslinked structure formed by the use of the later-described epoxy crosslinking agent, the monomer to be copolymerized with the (meth)acrylate is preferably a carboxyl group-containing monomer, most preferably (meth)acrylic acid, in order to impart moderate flexibility, elongation and strength to the acrylic sheet.

When the acrylic sheet of the invention is formed from a crosslinked acrylic polymer having a crosslinked structure formed by the use of the later-described isocyanate compound, the monomer to be copolymerized with the (meth)acrylate is preferably a hydroxyl group-containing monomer in order to impart moderate flexibility, elongation and strength to the acrylic sheet.

The crosslinked acrylic polymer having a crosslinked structure formed by the use of the epoxy crosslinking agent or the isocyanate crosslinking agent exhibits moderate flexibility, elongation and strength when molded into a sheet.

For preparing the acrylic copolymer, a vinyl group-containing monomer may be copolymerized in addition to the alkyl (meth)acrylate and the monomer containing in its molecule a functional group reactive to an epoxy group with the proviso that the acrylic copolymer has a glass transition temperature (Tg) of −10 to 30° C. Examples of such monomers include styrene, methylstyrene, vinyl acetate, vinylidene chloride, acrylonitrile and methacrylonitrile.

The mixing ratio between the alkyl (meth)acrylate, the monomer containing a functional group reactive to an epoxy group and the vinyl group-containing monomer has only to be determined so that the glass transition temperature (Tg) of the (co)polymer becomes −10 to 30° C., but usually they are used in the following amounts. When the epoxy crosslinking agent is used as a crosslinking agent, the monomer containing a functional group reactive to an epoxy group is used in an amount of 1 to 20 parts by weight, preferably 2 to 15 parts by weight, and the vinyl group-containing monomer is used in an amount of 0 to 20 parts by weight, preferably 0 to 15 parts by weight, each amount being based on 100 parts by weight of the alkyl (meth)acrylate. When the isocyanate crosslinking agent is used as a crosslinking agent, the monomer containing a functional group reactive to an isocyanate group is used in an amount of 0.1 to 20 parts by weight, and the vinyl group-containing monomer is used in an amount of 0 to 20 parts by weight. Preferably, the monomer containing a functional group reactive to an isocyanate group is used in an amount of 2 to 15 parts by weight, and the vinyl group-containing monomer is used in an amount of 0 to 15 parts by weight.

In the preparation of the acrylic polymer, it is necessary to copolymerize the monomer containing a functional group reactive to an epoxy group or an isocynate group. Since the monomer containing a functional group is usually soluble in water, the polymerization to prepare the acrylic polymer is preferably bulk polymerization or solution polymerization. In consideration of blendability with the later-described epoxy crosslinking agent or isocyanate crosslinking agent, the solution polymerization is optimum.

The weight-average molecular weight of the acrylic polymer (uncrosslinked polymer), as determined by gel permeation chromatography (GPC), is in the range of 100000 to 500000, preferably 120000 to 300000. If the weight-average molecular weight exceeds 500000, the resulting sheet becomes rigid and is lowered in the curved surface-follow properties. If the weight-average molecular weight is less than 100000, the resulting sheet is liable to have insufficient strength.

The epoxy crosslinking agent used for the acrylic sheet of the invention is a compound having two or more epoxy groups in its molecule, and is preferably a compound having two or more epoxy groups and having one or more tertiary nitrogen atoms, such as N,N-diglycidylaniline, N,N-diglycidyltoluidine, m-N,N-diglycidylaminophenylglycidyl ether, triglycidyl isocyanurate, N,N,N′,N′-tetraglycidylaminophenylmethane, N,N,N′,N′-tetraglycidyl-m-xylylenediamine or 1,3-bis(N,N-diglycidylaminomethyl)cyclohexane.

The crosslinked structure of the acrylic sheet of the invention is obtained by mixing the acrylic polymer with the epoxy crosslinking agent and heating the mixture at a temperature of usually not lower than 60° C. Prior to the mixing, the acrylic polymer and the epoxy crosslinking agent may be diluted with a solvent or the like according to circumstances. With respect to the mixing ratio between the acrylic polymer and the epoxy crosslinking agent, the epoxy crosslinking agent needs to be used in an amount of 0.1 to 10 parts by weight and is preferably used in an amount of 0.2 to 5 parts by weight, based on 100 parts by weight of the acrylic polymer. By the use of the epoxy crosslinking agent in this amount, the resulting acrylic sheet exhibits excellent strength and elongation, and when the acrylic sheet is stuck to a three-dimensional curved surface, the curved surface-follow properties of the sheet is excellent.

The acrylic sheet having been crosslinked with the epoxy crosslinking agent as described above has high crosslink density, and the gel fraction of the sheet, as measured by the use of ethyl acetate at 25° C., becomes usually 85 to 98%.

The isocyanate crosslinking agent used for the acrylic sheet of the invention is a compound having two or more isocyanate groups in its molecule. Examples of such compounds include isocyanate monomers, such as tolylene diisocyanate (TDI), chlorophenylene diisocyanate, hexamethylene diisocyanate, tetramethylene diisocyanate, isophorone diisocyanate, diphenylmethane diisocyanate and hydrogenated diphenylmethane diisocyanate; isocyanate compounds, isocyanurate compounds and biuret type compounds, which are obtained by the addition reaction of the above isocyanate monomers with trimethylolpropane or the like; and urethane prepolymer type isocyanates obtained by the addition reaction of the above compounds with publicly known polyether polyol, polyester plyol, acrylic polyol, polybutadiene polyol, polyisoprene polyol or the like.

The crosslinked structure formed in the acrylic sheet of the invention is obtained by mixing the acrylic polymer with the isocyanate crosslinking agent and heating the mixture at a temperature of usually not lower than 60° C. Prior to the mixing, the acrylic polymer and the isocyanate crosslinking agent may be diluted with a solvent or the like according to circumstances. With respect to the mixing ratio between the acrylic polymer and the isocyanate crosslinking agent, the isocyanate crosslinking agent needs to be used in an amount of 1 to 30 parts by weight and is preferably used in an amount of 5 to 20 parts by weight, based on 100 parts by weight of the acrylic polymer. By the use of the isocyanate crosslinking agent in this amount, the resulting acrylic sheet has high strength and excellent elongation and exhibits excellent three-dimensional curved surface-follow properties.

The acrylic sheet having been crosslinked with the isocyanate crosslinking agent has high crosslink density, and the gel fraction of the sheet, as measured by the use of ethyl acetate at 25° C., becomes usually 75 to 98%.

The thickness of the acrylic sheet of the invention is preferably in the range of 0.005 mm to 0.2 mm. If the acrylic sheet having a thickness of more than 0.2 mm is used as a decorative sheet, the edge portion of the sheet is undesirably liable to peel off when external stress is applied thereto, and uneven appearance is brought about.

The acrylic sheet of the invention has printability equal to that of a vinyl chloride sheet, so that printing can be easily made on this sheet by screen printing, gravure printing or the like.

The acrylic polymer can be colored before it is molded into a sheet. Coloring of the sheet can be made by the use of any of a pigment and a dye. A period of addition of the pigment or the dye is not limited. For example, the pigment or the dye may be mixed when the epoxy crosslinking agent or the isocyanate crosslinking agent is mixed, whereby a colored sheet can be obtained. In the use of dyes, some dyes may react with the functional group of the acrylic polymer, the epoxy group of the epoxy crosslinking agent or the isocyanate group of the isocyanate crosslinking agent. For this reason and in consideration of weathering resistance of the colored sheet, a pigment is preferably employed.

The acrylic sheet of the invention hardly adheres to another acrylic sheet even when they are placed one upon the other. In case of a long-term storage, the acrylic sheet is preferably provided with an overcoating layer to inhibit blocking which may occur when the acrylic sheet is laminated on a resin film one surface of which has been subjected to release treatment.

For the overcoating layer, an acrylic polymer having a glass transition temperature (Tg) of 50 to 100° C. is preferably used in order to effectively inhibit blocking of the acrylic sheets and in order not to impair flexibility (strength and elongation) of the acrylic sheet of the invention. The thickness of the overcoating layer is in the range of usually 0.5 to 5 μm, preferably 1 to 3 μm.

The overcoating layer is preferably formed from an acrylic resin. If the overcoating layer is formed from a resin other than the acrylic resin, sufficiently high weathering resistance is not obtained in many cases. When a polymer having a glass transition temperature (Tg) of lower than 50° C. is used or the thickness of the overcoating layer is less than 0.5 μm, sufficiently high blocking resistance is not exhibited in some cases, even if the polymer is an acrylic resin. When a polymer having a glass transition temperature (Tg) of higher than 100° C. is used or the thickness of the overcoating layer exceeds 5 μm, the acrylic sheet with an overcoating layer according to the invention has poor flexibility.

The overcoating layer is formed on the acrylic sheet by, for example, a method wherein an overcoating layer-forming composition is directly applied onto the acrylic sheet and dried, a method wherein an acrylic sheet-forming composition is directly applied onto the overcoating layer and dried, a method wherein the acrylic sheet is transferred onto the overcoating layer, a method wherein the overcoating layer is transferred onto the acrylic sheet, or a method wherein the overcoating layer and the acrylic sheet are laminated together. Of these, the method wherein an acrylic sheet-forming composition is directly applied onto the overcoating layer and dried is most excellent in the adhesion properties between the acrylic sheet and the overcoating layer.

The acrylic sheet of the invention usually has no adhesion properties at room temperature. In order to stick the acrylic sheet onto a three-dimensional cured surface, therefore, an adhesive layer is formed on at least one surface of the acrylic sheet to prepare an acrylic adhesive sheet.

The acrylic adhesive sheet of the invention is a sheet comprising the acrylic sheet and an acrylic adhesive layer laminated thereon. As the acrylic adhesive, a hitherto known acrylic adhesive containing as a main component an acrylic polymer having a glass transition temperature (Tg) of not higher than 0° C. is employable. The acrylic adhesive sheet can be used for, for example, gasoline tank of motor-bicycle, line mark of automobile body and electric railcar, cutout letter of signboard display, protective sheet and masking sheet. Particularly, the acrylic adhesive sheet is favorable for gasoline tank of motor-bicycle.

With respect to the acrylic adhesive sheet of the invention, printing can be made after the acrylic adhesive is applied to form an adhesive layer on the surface of the acrylic sheet, or after printing is made on the acrylic sheet, the adhesive can be applied to form an adhesive layer. In these cases, the adhesive layer may be formed on the surface opposite to the print surface or the surface identical with the print surface.

Industrial Application

The acrylic sheet of the invention comprises a crosslinked acrylic polymer having a crosslinked structure obtained by crosslinking 100 parts by weight of an acrylic polymer, which is obtained by (co)polymerization of a monomer containing an alkyl (meth)acrylate as a main component and has a glass transition temperature (Tg) of −10 to 30° C., with 0.1 to 10 parts by weight of an epoxy crosslinking agent having two or more epoxy groups in its molecule and/or 1 to 30 parts by weight of an isocyanate crosslinking agent having two or more isocyanate groups in its molecule. This acrylic sheet has properties nearly equal to those of a vinyl chloride resin sheet. Moreover, the acrylic sheet has a crosslinked structure of high density formed by the epoxy crosslinking agent or the isocyanate crosslinking agent and thereby exhibits excellent strength and elongation. In addition, the acrylic sheet has excellent weathering resistance though it does not contain such a plasticizer as used in the vinyl chloride resin sheet but contains an alkyl acrylate as a main component, and the acrylic sheet has very little influence on the environment.

The acrylic adhesive sheet of the invention has excellent curved surface-follow properties, so that it exhibits excellent suitability for adhesion to a three-dimensional curved surface of a motor-bicycle gasoline tank or the like.

### EXAMPLE

The present invention is further described with reference to the following examples, but it should be construed that the invention is in no way limited to those examples.

### Preparation of Acrylic Polymer

### Preparation Example 1

In a 2-liter four-necked flask equipped with a stirrer, a thermometer, a nitrogen gas feed pipe and a cooling pipe, 250 g of butyl acrylate, 200 g of methyl methacrylate, 50 g of acrylic acid and 350 g of ethyl acetate were placed, and they were heated up to 75° C. in a stream of a nitrogen gas. Then, 1 g of azobisisobutyronitrile was introduced as a polymerization initiator, and the contents in the flask were homogeneously mixed and then cooled or heated to maintain the temperature at 75° C. After 2 hours from the first introduction of the initiator, 1 g of azobisisobutyronitrile was introduced again with stirring, and the contents in the flask were homogeneously mixed and then cooled or heated to maintain the temperature at 75° C. After 5 hours from the first introduction of the initiator, the reaction solution was cooled to 30° C., and 400 g of ethyl acetate was introduced into the solution to obtain an acrylic polymer solution (A-1) having a solid concentration of 40% by weight.

The weight-average molecular weight of an acrylic polymer in the acrylic polymer solution (A-1), as measured by gel permeation chromatography (GPC), was 200000, and the glass transition temperature (Tg) thereof, as determined by the Fox's formula, was 4.4° C.

### Preparation Example 2

An acrylic polymer solution (A-2) was obtained in the same manner as in Preparation Example 1, except that 200 g of 2-ethylhexyl acrylate and 250 g of methyl methacrylate were used instead of 250 g of butyl acrylate and 200 g of methyl methacrylate. The weight-average molecular weight of an acrylic polymer in the acrylic polymer solution (A-2), as measured by gel permeation chromatography (GPC), was 210000, and the glass transition temperature (Tg) thereof, as determined by the Fox's formula, was 22.8° C.

### Preparation Example 3

An acrylic polymer solution (C-1) was obtained in the same manner as in Preparation Example 1, except that 150 g of butyl acrylate and 300 g of methyl methacrylate were used instead of 250 g of butyl acrylate and 200 g of methyl methacrylate. The weight-average molecular weight of an acrylic polymer in the acrylic polymer solution (C-1), as measured by gel permeation chromatography (GPC), was 190000, and the glass transition temperature (Tg) thereof, as determined by the Fox's formula, was 37.4° C.

### Preparation Example 4

An acrylic polymer solution (C-2) was obtained in the same manner as in Preparation Example 1, except that 0.3 g of azobisisobutyronitrile was used instead of 1 g of azobisisobutyronitrile and the reaction temperature was changed to 68° C. from 75° C. The weight-average molecular weight of an acrylic polymer in the acrylic polymer solution (C-2), as measured by gel permeation chromatography (GPC), was 580000, and the glass transition temperature (Tg) thereof, as determined by the Fox's formula, was 4.4° C.

### Preparation Example 5

An acrylic polymer solution (C-3) was obtained in the same manner as in Preparation Example 1, except that 0.5 g of dodecylmercaptan was further added when ethyl acetate was introduced. The weight-average molecular weight of an acrylic polymer in the acrylic polymer solution (C-3), as measured by gel permeation chromatography (GPC), was 60000, and the glass transition temperature (Tg) thereof, as determined by the Fox's formula, was 4.4° C.

### Preparation Example 6

In a 2-liter four-necked flask equipped with a stirrer, a thermometer, a nitrogen gas feed pipe and a cooling pipe, 200 g of butyl acrylate, 250 g of methyl methacrylate, 50 g of 2-hydroxyethyl acrylate and 350 g of ethyl acetate were placed, and they were heated up to 75° C. in a stream of a nitrogen gas. Then, 1 g of azobisisobutyronitrile was introduced as a polymerization initiator, and the contents in the flask were homogeneously mixed and then cooled or heated to maintain the temperature at 75° C. After 2 hours from the first introduction of the initiator, 1 g of azobisisobutyronitrile was introduced again with stirring, and the contents in the flask were homogeneously mixed and then cooled or heated to maintain the temperature at 75° C. After 5 hours from the first introduction of the initiator, the reaction solution was cooled to 30° C., and 400 g of ethyl acetate was introduced into the solution to obtain an acrylic polymer solution (A-3) having a solid concentration of 40% by weight.

The weight-average molecular weight of an acrylic polymer in the acrylic polymer solution (A-3), as measured by gel permeation chromatography (GPC), was 200000, and the glass transition temperature (Tg) thereof, as determined by the Fox's formula, was 9.7° C.

### Preparation Example 7

An acrylic polymer solution (A-4) was obtained in the same manner as in Preparation Example 6, except that 245 g of butyl acrylate, 200 g of methyl methacrylate, 50 g of acrylic acid and 5 g of 2-hydroxyethyl acrylate were used instead of 200 g of butyl acrylate, 250 g of methyl methacrylate and 50 g of 2-hydroxyethyl acrylate. The weight-average molecular weight of an acrylic polymer in the acrylic polymer solution (A-4), as measured by gel permeation chromatography (GPC), was 210000, and the glass transition temperature (Tg) thereof, as determined by the Fox's formula, was 4.9° C.

### Preparation Example 8

An acrylic polymer solution (C-4) was obtained in the same manner as in Preparation Example 6, except that 100 g of butyl acrylate, 350 g of methyl methacrylate and 50 g of 2-hydroxyethyl acrylate were used instead of 200 g of butyl acrylate, 250 g of methyl methacrylate and 50 g of 2-hydroxyethyl acrylate. The weight-average molecular weight of an acrylic polymer in the acrylic polymer solution (C-4), as measured by gel permeation chromatography (GPC), was 190000, and the glass transition temperature (Tg) thereof, as determined by the Fox's formula, was 44.2° C.

### Preparation Example 9

An acrylic polymer solution (C-5) was obtained in the same manner as in Preparation Example 6, except that 0.3 g of azobisisobutyronitrile was used instead of 1 g of azobisisobutyronitrile and the reaction temperature was changed to 68° C. from 75° C. The weight-average molecular weight of an acrylic polymer in the acrylic polymer solution (C-5), as measured by gel permeation chromatography (GPC), was 580000, and the glass transition temperature (Tg) thereof, as determined by the Fox's formula, was 9.7° C.

### Preparation Example 10

An acrylic polymer solution (C-6) was obtained in the same manner as in Preparation Example 6, except that 0.5 g of dodecylmercaptan was further added when ethyl acetate was introduced. The weight-average molecular weight of an acrylic polymer in the acrylic polymer solution (C-6), as measured by gel permeation chromatography (GPC), was 60000, and the glass transition temperature (Tg) thereof, as determined by the Fox's formula, was 9.7° C.

### Preparation of Acrylic Adhesive

### Preparation Example 11

In a 2-liter four-necked flask equipped with a stirrer, a thermometer, a nitrogen gas feed pipe and a cooling pipe, 475 g of butyl acrylate, 25 g of acrylic acid and 350 g of ethyl acetate were placed, and they were heated up to 70° C. in a stream of a nitrogen gas. Then, 0.5 g of azobisisobutyronitrile was introduced as a polymerization initiator, and the contents in the flask were homogeneously mixed and then cooled or heated to maintain the temperature at 70° C. for 8 hours. Then, the reaction solution was cooled to 30° C., and 580 g of ethyl acetate was introduced into the solution to obtain an acrylic polymer solution (adhesive solution P-1) having a solid concentration of 35% by weight.

The weight-average molecular weight of an acrylic polymer in the acrylic polymer solution, as measured by gel permeation chromatography (GPC), was 450000.

### Preparation of Overcoating Layer-forming Acrylic Polymer

### Preparation Example 12

In a 2-liter four-necked flask equipped with a stirrer, a thermometer, a nitrogen gas feed pipe and a cooling pipe, 50 g of butyl acrylate, 400 g of methyl methacrylate, 50 g of 4-hydroxybutyl acrylate and 350 g of ethyl acetate were placed, and they were heated up to 70° C. in a stream of a nitrogen gas. Then, 1.5 g of azobisisobutyronitrile was introduced as a polymerization initiator, and the contents in the flask were homogeneously mixed and then cooled or heated to maintain the temperature at 70° C. for 2 hours. Then, 1.5 g of azobisisobutyronitrile was introduced again, and the contents in the flask were heated to 80° C. After the temperature was maintained at 80° C. for 4 hours, the reaction solution was cooled, and 820 g of ethyl acetate was introduced into the solution to obtain solution (B-1) containing an overcoating layer-forming acrylic polymer which has a weight-average molecular weight, as measured by gel permeation chromatography (GPC), of 100000 having a solid concentration of 30% by weight and a viscosity of 0.5 Pa·s. The glass transition temperature (Tg) of the resulting polymer, as determined by the Fox's formula, was 62° C.

### Preparation Example 13

Solution (B-2) containing an overcoating layer-forming acrylic polymer which has a weight-average molecular weight, as measured by gel permeation chromatography (GPC), of 100000 and having a solid concentration of 30% by weight and a viscosity of 1.2 Pa·s was obtained in the same manner as in Preparation Example 12, except that 50 g of acrylic acid was used instead of 50 g of 4-hydroxybutyl acrylate. The glass transition temperature (Tg) of the resulting polymer, as determined by the Fox's formula, was 80° C.

### Evaluation of Acrylic Sheet

### Tensile Test (Strength and Elongation)

A sheet was cut into a size of 25 mm (width)×70 mm (length), and the thus cut sheet was extended at an extension rate of 200 mm/min in accordance with JIS K7127 to measure a strength at break and an elongation at break.

### Evaluation of Acrylic Adhesive Sheet

### Curved Surface-follow Property Test

A test pattern was printed on an acrylic sheet side surface of a test adhesive sheet by screen printing. After the printing, the test sheet was allowed to stand for 7 days at room temperature. Then, the test sheet was cut into a square of 10 cm×10 cm. The square sheet was stuck to a stainless steel sphere having a diameter of 5 cm in such a manner that the printed surface was not extended, and occurrence of wrinkle was observed. An adhesive sheet having no wrinkle was evaluated as AA, an adhesive sheet partially having wrinkle was evaluated as BB, and an adhesive sheet nearly entirely having wrinkle was evaluated as CC.

### Evaluation of Acrylic Sheet with Overcoating Layer

### Anti-Blocking Effect Test

A test film consisting of two layers of an overcoating layer and an acrylic sheet was laminated on a polyethylene terephthalate film (trade name: PET-5011, available from Lintec Corporation) of 50 μm thickness, one surface of said polyethylene terephthalate film having been subjected to release treatment, in such a manner that the acrylic sheet side surface of the test film faced the release-treated surface of the polyethylene terephthalate film, to obtain a test sheet of a three-layer structure. This test sheet was cut into a B-5 size, and ten of the thus cut sheets were laminated one upon another, follwed by application of a load of 8 kg. Under application of the load, the resulting laminate was allowed to stand for 1 week at 40° C., then released from the load and cooled to 23° C., to evaluate degree of separation between the overcoating layer and the surface of the polyethylene terephthalate film having been subjected to no release treatment. An acrylic sheet whose overcoating layer could be easily separated by hand was evaluated as AA, and an acrylic sheet whose overcoating layer could be separated by hand but was separated with a sound was evaluated as BB.

### Tensile Test (Strength and Elongation)

A test film consisting of two layers of an overcoating layer and an acrylic sheet was subjected to the same evaluation test as the aforesaid test of the acrylic sheet.

### Example 1

250 Grams of the acrylic polymer solution (A-1) and 1.5 g of 1,3-bis(N,N-diglycidylaminomethyl)cyclohexane (trade name: Tetrad C, available from Mitsubishi Gas Kagaku K.K.) as a crosslinking agent were mixed, and the mixture was applied onto a polyethylene terephthalate film (trade name: PET-5011, available from Lintec Corporation.) of 50 μm thickness having been subjected to release treatment, by the use of a doctor blade in such a manner that the thickness of the coated layer would be 50 μm on dry basis. The film with the coated layer was heated and dried by a dryer at 70° C. for 5 minutes and then allowed to stand still for 10 days at 23° C. to obtain an acrylic sheet having been crosslinked with an epoxy crosslinking agent. The results of the tensile test of the acrylic sheet are set forth in Table 1.

### Example 2

An acrylic sheet was obtained in the same manner as in Example 1, except that 3 g of N,N,N′,N′-tetraglycidyl-m-xylylenediamine (trade name: Tetrad X, available from Mitsubishi Gas Kagaku K.K.) was mixed instead of 1,3-bis(N,N-diglycidylaminomethyl)cyclohexane as a crosslinking agent. The results of the tensile test of the acrylic sheet are set forth in Table 1.

### Example 3

An acrylic sheet was obtained in the same manner as in Example 1, except that the acrylic polymer solution (A-2) was used instead of the acrylic polymer solution (A-1). The results of the tensile test of the acrylic sheet are set forth in Table 1.

### Comparative Examples 1, 2 and 3

An acrylic sheet was obtained in the same manner as in Example 1, except that the acrylic polymer solutions (C-1), (C-2) and (C-3) were each used instead of the acrylic polymer solution (A-1). The results of the tensile test of the acrylic sheet are set forth in Table 1.

### Example 4

250 Grams of the acrylic polymer solution (A-3) and 5 g of a tolylene diisocyanate addition product of trimethylolpropane (trade name: Colonate L, available from Nippon Polyurethane Kogyo K.K.) as a crosslinking agent were mixed, and the mixture was applied onto a polyethylene terephthalate film (trade name: PET-5011) of 50 μm thickness having been subjected to release treatment, by the use of a doctor blade in such a manner that the thickness of the coated layer would be 50 μm on dry basis. The film with the coated layer was heated and dried by a dryer at 70° C. for 5 minutes and then allowed to stand still for 10 days at 23° C. to obtain an acrylic sheet having been crosslinked with an isocyanate crosslinking agent. The results of the tensile test of the acrylic sheet are set forth in Table 1.

### Example 5

An acrylic sheet was obtained in the same manner as in Example 4, except that 15 g of a hexamethylene diisocyanate addition product of trimethylolpropane (trade name: Colonate HL, available from Nippon Polyurethane Kogyo K.K.) was mixed instead of 10 g of the tolylene diisocyanate addition product of trimethylolpropane as a crosslinking agent. The results of the tensile test of the acrylic sheet are set forth in Table 1.

### Example 6

An acrylic sheet was obtained in the same manner as in Example 4, except that the acrylic polymer solution (A-4) was used instead of the acrylic polymer solution (A-3). The results of the tensile test of the acrylic sheet are set forth in Table 1.

### Comparative Examples 4, 5 and 6

An acrylic sheet was obtained in the same manner as in Example 4, except that the acrylic polymer solutions (C-4), (C-5) and (C-6) were each used instead of the acrylic polymer solution (A-3). The results of the tensile test of the acrylic sheet are set forth in Table 1.

TABLE 1

| | Strength (N/mm²) | Elongation (%) |
|---|---|---|
| Ex. 1 | 14.7 | 150 |
| Ex. 2 | 18.4 | 150 |
| Ex. 3 | 16.1 | 130 |
| Comp. Ex. 1 | 24.5 | 30 |
| Comp. Ex. 2 | 23.7 | 60 |
| Comp. Ex. 3 | 5.4 | 310 |
| Ex. 4 | 19.0 | 140 |
| Ex. 5 | 14.7 | 150 |
| Ex. 6 | 16.8 | 160 |
| Comp. Ex. 4 | 32.3 | 30 |
| Comp. Ex. 5 | 29.2 | 70 |
| Comp. Ex. 6 | 4.6 | 440 |

### Example 7

25 Grams of the adhesive solution (P-1) obtained in Preparation Example 11, 25 g of ethyl acetate and 0.01 g of an epoxy crosslinking agent (trade name: Tetrad X, available from Mitsubishi Gas Kagaku K.K.) were mixed, and the mixture was applied onto a polyethylene terephthalate film (trade name: PET-3811, available from Lintec Corporation) of 50 μm thickness having been subjected to release treatment, by the use of a doctor blade in such a manner that the thickness of the coated layer would be 25 μm on dry basis. The film with the coated layer was heated and dried by a dryer at 70° C. for 3 minutes to form an adhesive layer on the film. The adhesive layer of the film was stuck to one surface of the acrylic sheet obtained in Example 1, and they were allowed to stand still for 10 days at 23° C. to obtain an acrylic adhesive sheet. The curved surface-follow properties of the acrylic adhesive sheet are set forth in Table 2.

### Examples 8-12

An acrylic adhesive sheet was obtained in the same manner as in Example 7, except that the acrylic sheets obtained in Examples 2 to 6 were each used instead of the acrylic sheet obtained in Example 1. The curved surface-follow properties of the acrylic adhesive sheet are set forth in Table 2.

### Comparative Examples 7-12

An acrylic adhesive sheet was obtained in the same manner as in Example 7, except that the acrylic sheets obtained in Comparative Examples 1 to 6 were each used instead of the acrylic sheet obtained in Example 1. The curved surface-follow properties of the acrylic adhesive sheet are set forth in Table 2.

TABLE 2

| | Curved surface-follow |
|---|---|
| | properties |
| Example 7 | AA |
| Example 8 | AA |
| Example 9 | AA |
| Example 10 | AA |
| Example 11 | AA |
| Example 12 | AA |
| Comparative Example 7 | BB |
| Comparative Example 8 | CC |
| Comparative Example 9 | CC |
| Comparative Example 10 | CC |
| Comparative Example 11 | CC |
| Comparative Example 12 | BB |

### Example 13

The overcoating layer-forming acrylic polymer solution (B-1) obtained in Preparation Example 12 was applied onto a polyethylene terephthalate film (trade name: PET-5011) of 50 μm thickness having been subjected to release treatment, by the use of a doctor blade in such a manner that the thickness of the coated layer would be 2 μm on dry basis. The film with the coated layer was dried by a dryer at 70° C. to form an overcoating layer on the film. Subsequently, on the overcoating layer was laminated an acrylic sheet of 50 μm thickness on dry basis obtained in the same manner as in Example 1. Thus, an acrylic sheet with an overcoating layer (F-1), consisting of an acrylic sheet and an overcoating layer, was obtained. The anti-blocking properties and the results of the tensile test of the acrylic sheet with an overcoating layer are set forth in Table 3.

### Example 14

An acrylic sheet with an overcoating layer (F-2) was obtained in the same manner as in Example 13, except that the overcoating layer-forming acrylic polymer solution (B-2) was used instead of the overcoating layer-forming acrylic polymer solution (B-1). The anti-blocking properties and the results of the tensile test of the acrylic sheet with an overcoating layer are set forth in Table 3.

### Example 15

The overcoating layer-forming acrylic polymer solution (B-1) obtained in Preparation Example 12 was applied onto a polyethylene terephthalate film (trade name: PET-5011) of 50 μm thickness having been subjected to release treatment, by the use of a doctor blade in such a manner that the thickness of the coated layer would be 2 μm on dry basis. The film with the coated layer was dried by a dryer at 70° C. to form an overcoating layer on the film. Subsequently, on the overcoating layer was laminated an acrylic sheet of 50 μm thickness on dry basis obtained in the same manner as in Example 4. Thus, an acrylic sheet with an overcoating layer (F-3), consisting of an acrylic sheet and an overcoating layer, was obtained. The anti-blocking properties and the results of the tensile test of the acrylic sheet with an overcoating layer are set forth in Table 3.

### Comparative Example 13

An acrylic sheet with an overcoating layer (CF-1) was obtained in the same manner as in Example 13, except that the thickness of the overcoating layer was changed to 7 μm. The anti-blocking properties and the results of the tensile test of the acrylic sheet with an overcoating layer are set forth in Table 3.

### Comparative Example 14

An acrylic sheet with an overcoating layer (CF-2) was obtained in the same manner as in Example 13, except that the thickness of the overcoating layer was changed to 0.3 μm. The anti-blocking properties and the results of the tensile test of the acrylic sheet with an overcoating layer are set forth in Table 3.

TABLE 3

| | Anti-blocking | Strength | Elongation |
|---|---|---|---|
| | effect | (N/mm²) | (%) |
| Ex. 13 | AA | 20.6 | 140 |
| Ex. 14 | AA | 19.4 | 140 |
| Ex. 15 | AA | 18.6 | 150 |
| Comp. Ex. 13 | AA | 35.2 | 10 |
| Comp. Ex. 14 | BB | 19.6 | 160 |

### Example 16

25 Grams of the adhesive solution (P-1) obtained in Preparation Example 11, 25 g of ethyl acetate and 0.01 g of an epoxy crosslinking agent (trade name: Tetrad X, available from Mitsubishi Gas Kagaku K.K.) were mixed, and the mixture was applied onto a polyethylene terephthalate film (trade name: PET-3811, available from Lintec Corporation.) of 38 μm thickness having been subjected to release treatment, by the use of a doctor blade in such a manner that the thickness of the coated layer would be 25 μm on dry basis. The film with the coated layer was heated and dried by a dryer at 70° C. for 3 minutes to form an adhesive layer on the film. The adhesive layer of the film was sstcuk to the non-overcoating layer side surface of the acrylic sheet with an overcoating layer obtained in Example 13, and they were allowed to stand still for 10 days at 23° C. to obtain an acrylic adhesive sheet with an overcoating layer. The curved surface-follow properties of the acrylic adhesive sheet with an overcoating layer are set forth in Table 4.

### Examples 17 and 18

An acrylic adhesive sheet with an overcoating layer was obtained in the same manner as in Example 16, except that the acrylic sheets with an overcoating layer obtained in Examples 14 and 15 were each used instead of the acrylic sheet with an overcoating layer obtained in Example 13. The curved surface-follow properties of the acrylic adhesive sheet with an overcoating layer are set forth in Table 4.

### Comparative Examples 15 and 16

An acrylic adhesive sheet with an overcoating layer was obtained in the same manner as in Example 16, except that the acrylic sheets with an overcoating layer obtained in Comparative Examples 13 and 14 were each used instead of the acrylic sheet with an overcoating layer obtained in Example 13. The curved surface-follow properties of the acrylic adhesive sheet with an overcoating layer are set forth in Table 4.

TABLE 4

| | Curved surface-follow |
|---|---|
| | properties |
| Example 16 | AA |
| Example 17 | AA |
| Example 18 | AA |
| Comparative Example 15 | BB |
| Comparative Example 16 | AA |

What is claimed is:

1. An acrylic sheet comprising a crosslinked acrylic polymer having a structure obtained by crosslinking 100 parts by weight of an acrylic polymer, which is a (co)polymer of a monomer containing an alkyl (meth)acrylate as a main component and has a glass transition temperature (Tg) of −10 to 30° C. and a weight-average molecular weight, as measured by gel permeation chromatography (GPC), of 100000 to 500000, with 0.1 to 10 parts by weight of an epoxy crosslinking agent having two or more epoxy groups in its molecule and/or 1 to 30 parts by weight of an isocyanate crosslinking agent having two or more isocyanate groups in its molecule.

2. The acrylic sheet as claimed in claim 1, which has a thickness of 0.005 to 0.2 mm.

3. The acrylic sheet as claimed in claim 1, which has, on at least one surface, an overcoating layer comprising an acrylic polymer and having a thickness of 0.5 to 5 μm.

4. The acrylic sheet as claimed in claim 3, wherein the acrylic polymer for forming the overcoating layer has a glass transition temperature (Tg) of 50 to 100° C.

5. An acrylic adhesive sheet comprising an acrylic sheet and an adhesive layer formed on at least one surface of the acrylic sheet, wherein the acrylic sheet comprises a crosslinked acrylic polymer having a structure obtained by crosslinking 100 parts by weight of an acrylic polymer, which is a (co)polymer of a monomer containing an alkyl (meth)acrylate as a main component and has a glass transition temperature (Tg) of −10 to 30° C. and a weight-average molecular weight, as measured by gel permeation chromatography (GPC), of 100000 to 500000, with 0.1 to 10 parts by weight of an epoxy crosslinking agent having two or more epoxy groups in its molecule and/or 1 to 30 parts by weight of an isocyanate crosslinking agent having two or more isocyanate groups in its molecule.

6. The acrylic adhesive sheet as claimed in claim 5, wherein the acrylic sheet has a thickness of 0.005 to 0.2 mm.

7. The acrylic sheet as claimed in claim 5, wherein the acrylic sheet has, on at least one surface, an overcoating layer comprising an acrylic polymer and having a thickness of 0.5 to 5 μm.

8. The acrylic sheet as claimed in claim 7, wherein the acrylic polymer for forming the overcoating layer has a glass transition temperature (Tg) of 50 to 100° C.

9. The acrylic adhesive sheet as claimed in claim 5, wherein the adhesive layer is provided on a surface of the acrylic sheet where the overcoating layer is not formed.

10. The acrylic adhesive sheet as claimed in claim 5, which is an acrylic adhesive sheet comprising the acrylic sheet and an adhesive layer formed on at least one surface of the acrylic sheet, said adhesive layer being arranged on the acrylic sheet so that it can adhere to a surface of a gasoline tank.

11. The acrylic adhesive sheet as claimed in claim 7, which adheres to a surface of a gasoline tank of a motor-bicycle.
